(19) United States
(12) Patent Application Publication
(10) Pub. No.: US 2002/0149261 A1
(43) Pub. Date: Oct. 17, 2002

(54) Method and system for protecting electronics mounted on a vehicle

(75) Inventors: Lou Vierling, East Detroit, MI (US); John C. McCoy, Fayetteville, TN (US); Rafael Cobas Asensio, Jalisco (MX); Shawn Lance Tracy, Macomb, MI (US); Richard G. Sullivan, Lake Orion, MI (US)

Correspondence Address: LAURA M. SLENZAK, SIEMENS CORPORATION, 186 WOOD AVENUE SOUTH, ISELIN, NJ, 08830, US

(73) Assignee: Siemens VDO AUTOMOTIVE Corporation

(21) Appl. No.: 10/118,988

(22) Filed: Apr. 9, 2002

Related U.S. Application Data
(60) Provisional application No. 60/283,556, filed on Apr. 12, 2001.
(60) Provisional application No. 60/341,024, filed on Oct. 30, 2001.

(51) Int. Cl. B60L 1/00

(52) U.S. Cl. 307/9.1

(57) ABSTRACT

A vehicle power supply management system includes a load absorbing device (28, 32, 34) that absorbs an excess voltage from the vehicle battery (24). Under circumstances, such as at vehicle shutdown when an excess voltage spike occurs at the battery, the load absorbing device is selectively coupled to the battery to absorb the excess voltage and protect other electronic components on the vehicle. In one example, a comparator (44) compares the voltage on the battery (24) to a preselected threshold value (46). Whenever the battery voltage exceeds the threshold, the inventive arrangement selectively couples a load absorbing device, such as a plurality of glow plugs (28), heating elements within a vehicle seat (32) or a window defrost unit (34), for example, to the vehicle battery (24) to absorb the excess voltage.

### CROSS REFERENCE TO RELATED APPLICATIONS

This application claims priority to the U.S. Provisional Application No. 60/283,556, which was filed on Apr. 12, 2001 and No. 60/341,024 which was filed on Oct. 30, 2001.

### BACKGROUND OF THE INVENTION

This invention generally relates to a strategy for protecting electronics on a vehicle during load dump conditions. More particularly, this invention relates to a system and method for rapidly absorbing excess voltage during a load dump to protect electronics from excess voltage.

Vehicle power supplies typically include a battery and an alternator. Batteries typically are between 8 and 16 volts. An alternator works as well known in the industry.

The magnetic field buildup around the alternator typically collapses when the vehicle ignition is turned off. This results in a spike of electrical energy causing the battery voltage to spike to an unusually high level. It is necessary to absorb this spike so that electronic components supported on the vehicle are not exposed to an excess voltage which would damage or render those components inoperative.

One way of addressing the voltage spike is to provide a varistor or a transient absorber in parallel with the input power. Such devices conduct the excess voltage to ground in the event that the voltage rises to an undesirably high level. While such arrangements have proven useful, they are not without shortcomings and drawbacks.

One major concern in automotive applications is cost savings. Requiring an additional component such as a varistor or a transient absorber, introduces additional expense into a vehicle power supply control arrangement. Another issue that is always of concern in vehicle applications is packaging constraints. An additional component such as a varistor requires additional space on a board, for example, and therefore is undesirable.

There is a need for an improved arrangement that is capable of absorbing the voltage spike that occurs during a load dump at vehicle shutoff or at other times. This invention addresses that need while avoiding the shortcomings and drawbacks of the prior art.

### SUMMARY OF THE INVENTION

In general terms, this invention is a system for absorbing excess voltage in a vehicle power supply utilizing components already present on the vehicle having a low resistance and a high power absorption to absorb the excess voltage.

In one example system designed according to this invention, a voltage absorbing device is supported on the vehicle that normally has a separate function. A control portion selectively couples the absorbing device to the vehicle power supply when the voltage associated with the power supply exceeds a preselected threshold.

The low resistance, high power absorption load serves to absorb the excess voltage to avoid other components from being exposed to the high voltage.

In one example, the voltage absorbing load comprises a plurality of glow plugs. In another example, the voltage absorbing load comprises a window defroster supported on a glass panel of the vehicle. In another example, the load absorbing device comprises the heating elements within a heated seat in the vehicle interior.

A method of absorbing an excess voltage from a vehicle power supply designed according to this invention includes monitoring the voltage of the power supply. When the power supply exceeds a preselected threshold, at least one device supported on the vehicle is activated to absorb the excess voltage.

The preferred arrangement includes electronic switching so that the voltage absorption occurs fast enough to respond to the excess voltage before the voltage spike is able to affect any other electronic component supported on the vehicle.

The various features and advantages of this invention will become apparent to those skilled in the art from the following detailed description of the currently preferred embodiment. The drawings that accompany the detailed description can be briefly described as follows.

### BRIEF DESCRIPTION OF THE DRAWINGS

FIG. 1 illustrates a first example vehicle incorporating a system designed according to this invention.

FIG. 2 illustrates a second sample vehicle incorporating a system designed according to this invention.

FIG. 3 schematically illustrates one example implementation of this invention.

### DETAILED DESCRIPTION OF THE PREFERRED EMBODIMENTS

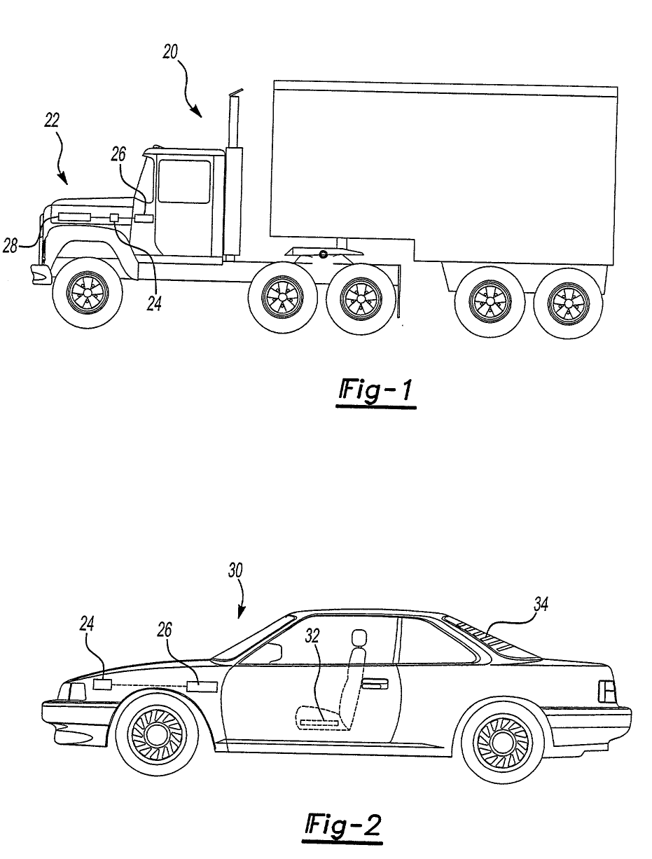

FIG. 1 illustrates a vehicle 20 having a power supply control system 22 designed according to this invention. As known, the vehicle 20, which is a truck in the example illustration of FIG. 1, includes a vehicle power supply having a battery 24 and an alternator (not illustrated). A controller 26 monitors the voltage of the battery 24 to determine when there is a voltage spike and when a load dump may occur, for example.

A plurality of glow plugs 28 are provided that operate in a known manner to provide heat to the diesel engine (not illustrated) in a conventional manner.

The controller 26 preferably operates the glow plugs 28 to absorb any excess voltage to avoid the possibility for other electronic components on the vehicle 20 from being damaged during a voltage spike typically associated with a load dump.

The glow plugs 28 are one example excess voltage absorbing device that is useful in a system designed according to this invention.

FIG. 2 illustrates another example vehicle 30 incorporating a system 22 designed according to this invention. The vehicle 30 includes two alternate excess voltage absorbing devices including heating elements 32 within a seat in the interior of the vehicle and a window defrosting unit 34 supported on the rear window glass of the vehicle in a known manner. The heating elements 32 and the defrosting unit 34 typically operate in a conventional fashion. According to this invention, however, they are additionally used as load absorbers for absorbing excess voltage that may be associated with a voltage spike occurring, for example, during load dump conditions.

According to this invention, when the voltage on the vehicle battery 24 exceeds a preselected threshold, the controller 26 operates to couple the battery 24 to the load absorbing device (i.e., the glow plugs 28, the heating elements 32 or the defrost unit 34) to absorb the excess voltage and avoid damage to other electronic components supported on the vehicle. In one example, the threshold is 28 volts. In another example, the threshold is twice the normal battery voltage.

The illustrated examples show several choices for the load absorbing device.

Others may be used and those skilled in the art who have the benefit of this description will realize what other devices on a vehicle may be used for purposes according to this invention. Provided that a load has low resistance and high power absorption, it can prove useful in a system designed according to this invention depending on the needs of a particular situation.

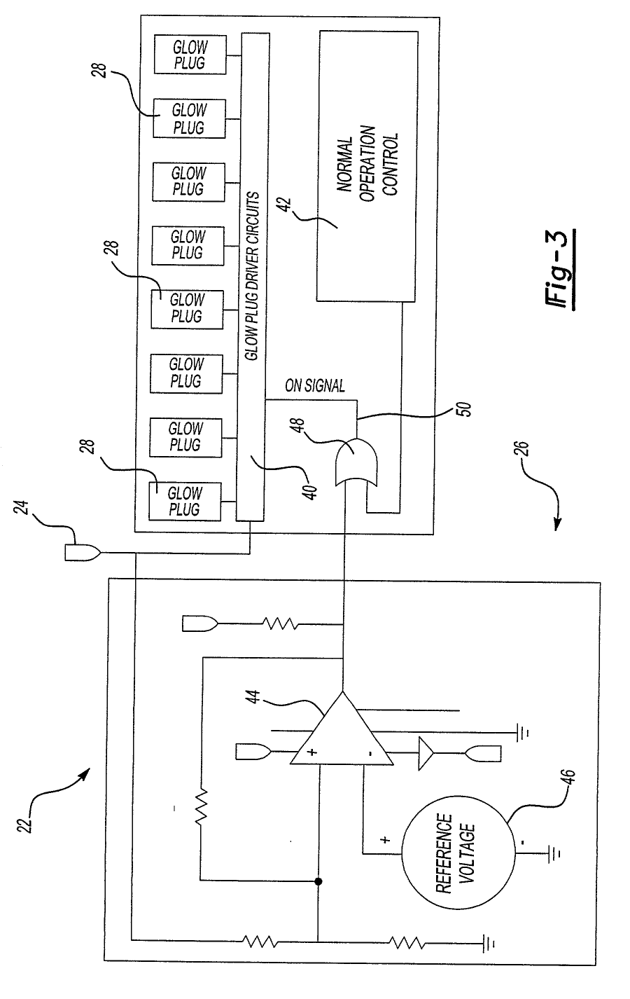

FIG. 3 schematically illustrates one example implementation of a system 22 designed according to this invention. In this example, the glow plugs 28 are the load absorbing device. Of course, the heating elements 32 or defrosting unit 34 could be substituted for the glow plugs 28 in the illustration of FIG. 3 and the accompanying description.

The glow plugs 28 are controlled by a conventional glow plug driver circuit arrangement 40, which is responsive to an activation signal from a controller 42 that controls the normal operation of the glow plugs 28. In one example, the glow plugs 28 are normally used to heat up portions of the diesel engine of the vehicle 20. The components used for the glow plug driver circuits 40 and the normal operation controller 42 are well known.

The controller 26 includes a comparator 44 that compares the voltage of the battery 24 to a reference voltage 46. In one example, the reference voltage 46 is provided by a suitably sized and charged capacitor appropriately coupled with the comparator 44. The illustrated example includes a comparator 44 with hysteresis to provide adequate system performance meeting the needs for quickly identifying a voltage spike at the battery 24 and rapidly addressing that situation so that the glow plugs 28 absorb the excess voltage.

The output of the comparator 44 is provided to the glow plug driver circuits 40 through an OR gate 48. The output 50 of the OR gate 48 provides an activation signal to the glow plug driver circuits 40 whenever the output of the comparator 44 indicates that the voltage of the battery 24 exceeds the preselected threshold reference 46 or by normal operation of the controller 42.

Under conditions where the voltage of the battery 24 exceeds the desired threshold, the glow plugs 28 are coupled to the battery 24 to absorb the excess voltage. The controller 26 preferably turns off the glow plugs 28 after the voltage of the battery 24 has returned to an acceptable level. In one example, the battery 24 normally has a 12 volt potential and the threshold voltage is 28 volts so that the comparator 44 provides the activation signal whenever the battery voltage equals or exceeds 28 volts. The particular voltage levels used for a given situation will vary depending on the needs associated with a particular arrangement. Those skilled in the art who have the benefits of this description will be able to select the appropriate operation parameters to address their situation.

It is most preferable to use electronic switching (i.e., solid state switches) to achieve a fast reaction to a voltage spike in the battery 24. At vehicle shutdown, for example, when the magnetic field around the alternator collapses, the voltage spike and the ensuing dump of that load occurs very rapidly. The system 22 preferably has a response time at the microsecond level so that the load absorbing device is activated in time to avoid the excess voltage from impacting any other electronics on the vehicle.

A significant advantage of this invention is provided by utilizing components already present on the vehicle to achieve the excess voltage absorption. This invention allows for more cost-effective and more compact packaging compared to systems that required additional components dedicated solely to the purpose of absorbing excess voltage.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A system for absorbing excess voltage in a vehicle power supply, comprising:
a load absorbing device having low resistance and high power absorption characteristics; and
a control portion that selectively couples the load absorbing device to the power supply when a voltage of the power supply exceeds a preselected threshold.

2. The system of claim 1, wherein the control portion stops the load absorbing device from absorbing the power supply voltage when the power supply voltage has returned below a selected level.

3. The system of claim 2, wherein the selected level equals the preselected threshold.

4. The system of claim 1, wherein the control portion includes a comparator that compares the power supply voltage to a reference that is indicative of the threshold.

5. The system of claim 4, including a load absorbing device control circuit and wherein the comparator provides an activation signal to the load absorbing device control circuit such that the load absorbing device absorbs the excess voltage.

6. The system of claim 5, wherein the load absorbing device control circuit includes driver circuits that activate the load absorbing device and the activation signal is received by an initializer portion of the control circuit to turn on the driver circuits.

7. The system of claim 1, wherein the load absorbing device comprises a plurality of glow plugs.

8. The system of claim 1, wherein the load absorbing device comprises heating elements within a vehicle seat.

9. The system of claim 1, wherein the load absorbing device comprises a window defrost unit.

10. A method of controlling a voltage level in a vehicle power supply, comprising the steps of:
determining a voltage level of a battery associated with the vehicle power supply;
comparing the determined voltage level to a preselected threshold; and
selectively coupling the battery to a load absorbing device when the voltage exceeds the threshold.

11. The method of claim 10, including selectively uncoupling the load absorbing device from the battery after the voltage level has returned below a selected level.

12. The method of claim 10, including activating a plurality of glow plugs to absorb the excess voltage from the battery.

13. The method of claim 10, including activating heating elements within a vehicle seat to absorb the excess voltage.

14. The method of claim 10, including activating a window defrost unit to absorb the excess voltage from the battery.
